(19) United States
(12) Patent Application Publication
(10) Pub. No.: US 2014/0335431 A1
(43) Pub. Date: Nov. 13, 2014

(54) FUEL CELL SEAL RETAINER ASSEMBLY

(71) Applicant: Michael E. Fortin, Andover, CT (US)

(72) Inventor: Michael E. Fortin, Andover, CT (US)

(73) Assignee: ClearEdge Power, LLC, South Windsor, CT (US)

(21) Appl. No.: 14/361,085

(22) PCT Filed: Nov. 28, 2011
(86) PCT No.: PCT/US2011/062219

§ 371 Date: May 28, 2014

(51) Int. Cl. H01M 8/24; H01M 8/04

(52) U.S. Cl. CPC H01M 8/2485; H01M 8/04201
USPC 429/428; 429/460

(57) ABSTRACT

An exemplary fuel cell manifold seal retainer assembly includes a bracket and a retainer. The bracket is mountable to a manifold of the fuel cell stack. The retainer extends closer to a fuel cell stack then the manifold when the retainer is mounted to the bracket and when the bracket is mounted to the manifold. The retainer limits movement of a seal away from an installed position.

### TECHNICAL FIELD

This disclosure relates generally to fuel cells and, more particularly, to maintaining a sealing arrangement of a fuel cell assembly.

### DESCRIPTION OF RELATED ART

Fuel cell assemblies are well known. Many fuel cell assemblies include a multiple of individual fuel cell units arranged in a stack. Pressure plates at opposing ends of the stack hold the fuel cell units.

In some examples, the fuel cell units each include electrode assemblies having a phosphoric acid layer that acts as an electrolyte. The electrolyte is positioned between electrodes. One of the electrodes operates as an anode. The other electrode operates as a cathode.

The fuel cell units typically utilize fluid fuels (e.g., hydrogen and air) and generate fluid byproducts (e.g., water). Manifolds are used to communicate the fuels to the fuel cell units and byproducts away from the fuel cell units. The manifolds are typically secured to the outwardly facing surfaces of the fuel cell units. Seals secured to the manifolds block flow from the manifolds. Seals can become misaligned during operation of the fuel cell stack providing a leak path for the fluid fuels and fluid byproducts. Replacing misaligned seals is costly.

### SUMMARY

An exemplary fuel cell manifold seal retainer assembly includes a bracket and a retainer. The bracket is mountable to a manifold of the fuel cell stack. The retainer extends closer to a fuel cell stack then the manifold when the retainer is mounted to the bracket and when the bracket is mounted to the manifold. The retainer limits movement of a seal away from an installed position.

An exemplary fuel cell stack assembly includes fuel cells arranged in a stack. First and a second pressure plates are positioned at opposing ends of the stack. A manifold communicates a fuel cell fluid to or from the stack. A seal limits movement of the fuel cell fluid from the manifold. A retainer extends closer to a fuel cell stack then the manifold. The retainer limits movement of a seal away from an installed position.

An exemplary method of maintaining a position of a fuel cell seal includes sealing an interface between a fuel cell manifold and a fuel cell stack using a seal. The method captures an enlarged area of the seal between a retainer and the manifold to limit relative movement between the seal and the manifold as the manifold moves relative to the fuel cell stack.

### DESCRIPTION OF THE FIGURES

The various features and advantages of the disclosed examples will become apparent to those skilled in the art from the detailed description. The figures that accompany the detailed description can be briefly described as follows:

FIG. 1 shows a schematic view of an example fuel cell stack assembly.

FIG. 2 shows a top view of a portion of the FIG. 1 fuel cell stack assembly.

FIG. 3 shows a section view at line 3-3 in FIG. 2.

FIG. 4 shows a bottom view of a retainer within the FIG. 1 fuel cell stack assembly.

FIG. 5 shows an interface between a first portion and a second portion of the FIG. 4 retainer.

FIG. 6 shows a section view of an alternative retainer assembly at line 3-3 in FIG. 2.

### DETAILED DESCRIPTION

Referring to FIG. 1, an example fuel cell stack assembly 10 includes several individual fuel cell units 12 arranged in a stack. Pressure plates 16 at opposing ends of stack hold the positions of the fuel cell units 12.

In this example, a manifold 20 delivers a fuel cell fluid, such as hydrogen, to the fuel cell units 12. The manifold is secured near a laterally outermost side of the stack of fuel cell units 12.

In FIG. 1, only the manifold 20 is shown for clarity. The fuel cell stack assembly 10 will typically include other manifolds. The other manifolds are each secured to another of the three laterally outermost sides of the stack of fuel cell units 12. The other manifolds (not shown) communicate liquid byproducts away from the fuel cell units 12, communicate air to the fuel cell units 12, etc.

A seal 24 is secured to the manifold 20. The seal 24 limits flow of the fuel cell fluid from the manifold 20. Similar seals are secured to the other manifolds.

During operation, the vertical height of the stack of fuel cell units 12 changes due to fluctuations in stack temperature. In one example, as the temperature of the fuel cell stack assembly 10 increases, the height of the stack of fuel cell units 12 increases in the direction D and the pressure plates 16 move further away from each other. As the temperature of the fuel cell stack assembly 10 decreases, the height of the stack of fuel cell units 12 decreases in a direction opposite the direction D.

In this example, thermal variations do not cause the size of the seal 24 and the manifold 20 to change at the same rate as the stack of fuel cell units 12. Thus, the thermal variations can cause the seals 24 to move relative to the stack and become unseated, which may cause leaks. Unseating is particularly prevalent near the top vertical edges 28 of the fuel cell stack assembly 10.

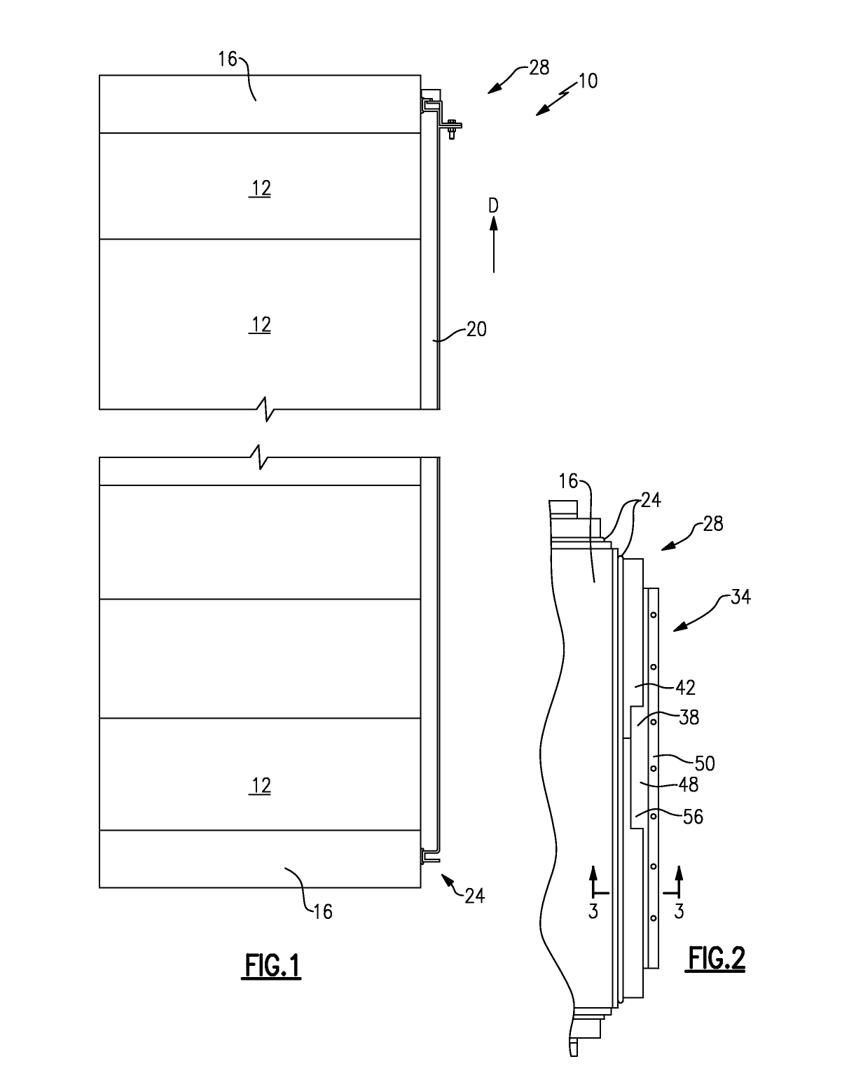

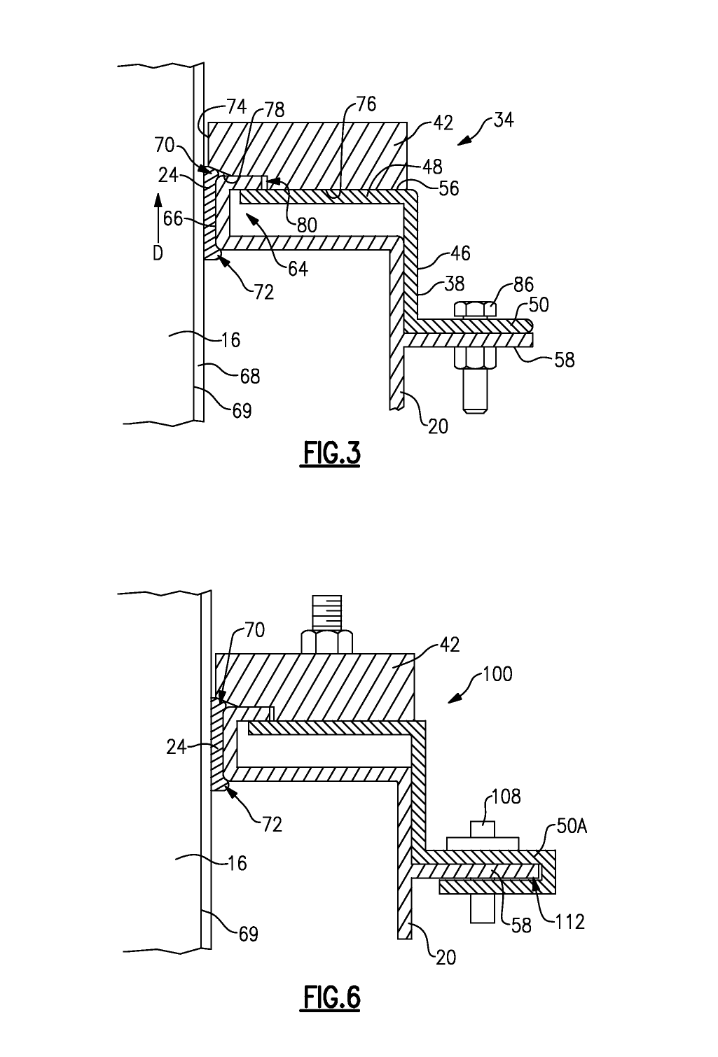

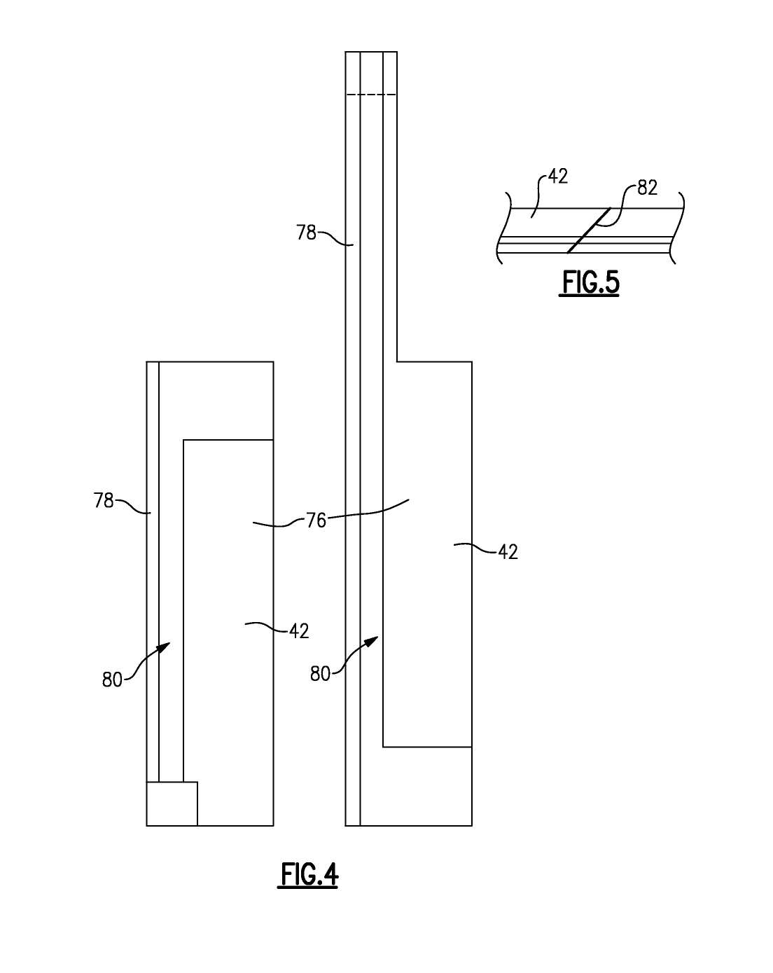

Referring to FIGS. 2-5 with continuing reference to FIG. 1, a seal retainer assembly 34 is used to maintain and hold the seal 24 in an installed (and seated) position as the height of stack of fuel cell units 12 changes relative to the position of the seal 24.

The example seal retainer assembly 34 includes a bracket 38 and a retainer 42. When the retainer 42 and bracket 38 are secured to the manifold 20, movement of the seal 24 relative to the manifold 20 is limited.

The example bracket 38 includes a vertically extending portion 46, a first horizontal portion 48, and a second horizontal portion 50. The first horizontal portion 48 and the second horizontal portion 50 are located at opposite ends of the vertically extending portion 46. The first horizontal portion 48 extends from the vertically extending portion 46 in an opposite direction from the second horizontal portion 50. The bracket 38 thus has a generally Z-shaped configuration.

The first horizontal portion 48 provides a mounting surface 56 for the retainer 42. Adhesive is used, in this example, to secure the retainer 42 to the mounting surface 56.

The second horizontal portion 50 is secured to an existing flange 58 of the manifold 20. A mechanical fastener 60 may be used to secure the second horizontal portion 50 to the flange 58.

When the retainer 42 is mounted to the manifold 20, the first horizontal portion 48 extends within a channel area 64 of the manifold 20. The channel area 64 of the manifold 20 includes a surface 66 that faces the pressure plate 16. The seal 24 is mounted to this surface 66 in this example. Adhesive, for example, may be used to secure the seal 24 to the surface 66.

The seal 24 directly contacts a friction-reducing sheet 68 that is attached to a laterally outer surface 69 of the pressure plate 16. The seal 24 moves relative to the sheet 68 as the vertical height of the stack of fuel cell units 12 changes due to thermal fluctuations.

The sheet 68 is a Teflon sheet in this example. The sheet 68 is used to lessen friction encountered by the seal 24 during such movements. In other examples, the seal 24 directly contacts the pressure plate 16.

Although the sheet 68 is used, friction can still cause the seal 24 to pull away from the seated and installed position.

In the installed position, the seal 24 includes an enlarged portion 70 extending outside the manifold 20 and an enlarged portion 72 extending inside the manifold 20. The retainer 42 holds the enlarged portion 70 to limit movement of the seal 24 when the stack of the fuel cell units 12 moves downward relative to the seal 24. The retainer 42 blocks movement of the seal 24 when the stack of fuel cell units 12 moves upward relative to the seal 24.

The retainer 42, in this example includes a surface 74 that faces the fuel cell stack assembly 10 and a surface 76 that directly contacts the mounting surface 56 of the retainer 42. An angled surface 78 extends between the surface 76 and the surface 74. The example retainer 42 also includes a notched area 80 that accommodates the portion of the manifold 20 forming the channel area 64.

The surface 74 extends closer to the sheet 68 than the surface 66. Movement of the seal 24 away from the surface 66 and outside the manifold 20 is blocked by the portion of the retainer 42 extending past the surface 66 toward the sheet 68.

The example retainer 42 includes two separate pieces, which meet at an overlapping joint 82. In other examples, the retainer 42 is a single piece.

In this example, the seal retainer assembly 34 is secured to only the upper vertical edge 28 of the manifold 20. Although the seal retainer assembly 34 could be used in other areas, the other areas of the manifold 20 do not move relative to the stack of fuel cell units 12 as much as the upper vertical edge 28.

In one example, the seal retainer 34 is used as a repairing device after the seal 24 has slipped from the installed position where the seal is secured directly to the surface 66. After recognizing that the seal 24 has slipped, an operator then attached the seal retainer assembly 34 to the manifold 20 using a mechanical fastener 86. The retainer assembly 42, once installed, causes the seal 24 to back into the installed position.

Referring to FIG. 6, another example seal retained assembly 100 includes the retainer 42 and a bracket 104. In this example, the bracket 104 is secured to the manifold 20 with drop-in pins 108 rather than the mechanical fasteners 60. The bracket 104 also includes a channeled area 112 that receives the flange 58 of the manifold 20. The channeled area 112 helps the connection of the bracket 104 to the flange 58 of the manifold 20.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

I claim:

1. A fuel cell manifold seal retainer assembly, comprising:
a bracket mountable to a manifold of a fuel cell stack; and
a retainer that extends closer to a fuel cell stack than the manifold when the retainer is mounted to the bracket and when the bracket is mounted to the manifold, wherein the retainer limits movement of a seal away from an installed position.

2. The fuel cell manifold seal retainer assembly of claim 1, wherein the bracket includes a vertical portion, a first horizontal portion extending from a first end of the vertical portion, and a second horizontal portion extending from an opposing, second end of the vertical portion.

3. The fuel cell manifold seal retainer assembly of claim 2, wherein the first and second horizontal portions extend in opposite directions from the vertical portion.

4. The fuel cell manifold seal retainer assembly of claim 2, wherein the first horizontal portion extends into an outer channel of the manifold when the bracket is mounted to the manifold.

5. The fuel cell manifold seal retainer assembly of claim 1, wherein the retainer mounts to a horizontally extending surface of the bracket.

6. The fuel cell manifold seal retainer assembly of claim 1, wherein the retainer comprises a resin-based fiberglass material.

7. The fuel cell manifold seal retainer assembly of claim 1, wherein the retainer includes a first surface facing the bracket, a second surface facing the fuel cell stack, and an angled surface extending from the first surface to the second surface.

8. The fuel cell manifold seal retainer assembly of claim 7, wherein the angled surface contacts the seal to limit movement of the seal away from the installed position.

9. The fuel cell manifold seal retainer assembly of claim 1, wherein the retainer includes a notched area that receives a portion of an outer channel of the manifold when the retainer is mounted to the bracket and the bracket is mounted to the manifold.

10. A fuel cell stack assembly, comprising:
a plurality of fuel cells arranged in a stack;
a first and a second pressure plate at opposing ends of the stack;
a manifold that communicates a fuel cell fluid to or from the stack;
a seal that limits movement of the fuel cell fluid from the manifold; and
a retainer that extends closer to a fuel cell stack than the manifold, wherein the retainer limits movement of a seal away from an installed position.

11. The fuel cell stack assembly of claim 10, including a sheet mounted to one of the pressure plates that interfaces with the seal, and the manifold includes a perimeter surface that also interfaces with the seal.

12. The fuel cell stack assembly of claim 11, wherein the sheet is a Teflon sheet.

13. The fuel cell stack assembly of claim 11, wherein seal moves with the manifold relative to the sheet during operation.

14. The fuel cell stack assembly of claim 10, wherein the seal includes an enlarged area inside the manifold and an enlarged area outside the manifold, and the retainer holds the enlarged area outside the manifold to limit movement of the seal.

15. The fuel cell stack assembly of claim 10, wherein the seal is a two-piece seal.

16. A method of maintaining a position of a fuel cell seal, comprising:
sealing an interface between a fuel cell manifold and a fuel cell stack using a seal; and
capturing an enlarged area of the seal between a retainer and the manifold to limit relative movement between the seal and the manifold as the manifold moves relative to the fuel cell stack.

17. The method of claim 16, including securing the retainer to a bracket that is mounted to the manifold.

18. The method of claim 17, wherein the retainer extends from the bracket closer to the fuel cell stack than the manifold when the retainer is secured to the bracket and the bracket is mounted to the manifold.
